(19) United States
(12) Patent Application Publication
(10) Pub. No.: US 2025/0214188 A1
(43) Pub. Date: Jul. 3, 2025

(54) UFS 2011/1911 ROUTER JIG

(71) Applicant: John Kyle Byrd, Rockingham, NC (US)

(72) Inventor: John Kyle Byrd, Rockingham, NC (US)

(21) Appl. No.: 18/772,165

(22) Filed: Jul. 13, 2024

Related U.S. Application Data
(60) Provisional application No. 63/616,923, filed on Jan. 2, 2024.

(51) Int. Cl. B23Q 3/00; B23Q 3/06

(52) U.S. Cl. CPC B23Q 3/005; B23Q 3/062; B23Q 2703/10

(57) ABSTRACT

An assembly of a router secured to a router base plate and an assembly of jig side plates between which is a work piece such as a frame piece of a pistol firearm. The former assembly is atop the later assembly. The router base plate has a boss inside of which a router guide bushing is rotatable. A guide rail attaches or fastens to the router base plate and aligns the router guide bushing to a locating edge of the one of the jig side plates to create a stable, supporting platform for the handheld router to stay mounted to the router base plate and that guides movement of the handheld router across the one of the jig side plates smoothly as the handheld router cuts rails of the work piece between the pair of jig side plates.

### CROSS-REFERENCE TO RELATED APPLICATIONS

Provisional patent application No. 63/616,923 filed Jan. 2, 2024 for which the present application asserts the benefit of priority.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB).

Not applicable.

### STATEMENT REGARDING PRIOR DISCLOSURES BY THE INVENTOR OR A JOINT INVENTOR

Not applicable.

### BACKGROUND OF THE INVENTION

### Field of the Invention

The UFS 2011/1911 Router Jig is a set/kit of multiple components used in conjunction with a handheld router, end mill, and drill bits. When assembled or attached to a 2011 or 1911 80% pistol frame, the jig enables the end user to complete or remove the remaining 20% of material to complete the frame to its usable attaining a 100% state. This completed or 100% state allows the end user to assemble the required components (slide, trigger, hammer, springs, pins or bars, etc. . . . ) with the now completed frame to make a functional firearm/pistol.

### Description of Related Art including Information Disclosed Under 37 CFR 1.97 and 1.98

I am an engineer, gunsmith and manufacturer of firearm components who noticed a need to create a jig that allows the normal person with basic mechanical knowledge to utilize basic and commonly available tools to finish or complete an 80% 2011 or 1911 pistol frame. At the time of my invention, I was unaware of any other designs that used a handheld router in conjunction with a jig or locating edges to complete the task of finishing an 80 percent 2011/1911 frame.

There are other so called “jigs” on the market that do not use or require a handheld router to complete the desired task. Some other designs or “jigs” require expensive and hard to acquire machinery and equipment to complete the frame. While other jigs require the operator or person to manually push a tool to scrape the metal from the pistol frame to finish the slide rails. Also, other designs or jigs are mostly marketed to complete softer materials, such as aluminum due to the heavy amount of human work required to finish the pistol frame.

According to an online article by Battle Hawk Armory at battlehawkarmory.com/blog/1911-vs-2011:

Designed in the early 20th century, the 1911 pistol was a response to the U.S. military's need for a more powerful sidearm. John Browning's design was selected as the winner of a series of trials conducted by the U.S. Army, and it was formally adopted as the standard-issue sidearm for the United States military in 1911. The pistol served the military faithfully through both World Wars, the Korean War, and the Vietnam War. It was only officially replaced in 1985 but continues to be used by some military and law enforcement units to this day.

The 1911 pistol is chambered for the .45 ACP cartridge, also designed by Browning. The ACP (Automatic Colt Pistol) cartridge is known for its stopping power, making it an excellent choice for self-defense. With a simple and robust design, the 1911 pistol is a single-stack, semi-automatic handgun that is reliable and accurate. The 1911's iconic design includes a grip safety, thumb safety, and a slide that locks back after the last round is fired.

Various manufacturers and brands have produced their versions of the 1911 pistol over

the years. Notable names include Springfield Armory, Rock Island Armory and Dan Wesson. Each has contributed to the 1911's legendary status, enhancing its features, aesthetics, and performance.

Even today, more than a century after its creation, the 1911 pistol continues to be cherished by shooting enthusiasts, collectors, and competitive shooters alike. It's a testament to John Browning's genius and the timeless appeal of this remarkable firearm.

The 2011 pistol represents a modern-day evolution of the iconic 1911 design, incorporating several modifications to cater to contemporary shooting demands. The most significant change in the 2011 design is the shift from a single-stack single to a double-stack double magazine. This modification allows the 2011 pistol to hold more rounds, increasing its capacity and making it a popular choice among competitive shooters. While this change makes the grip slightly thicker, the 2011 pistol manages to retain the comfortable and ergonomic grip frame that the 1911 is known for.

The 2011 pistol also features a modular design, allowing for greater customization. The grip module and the grip frame can be easily replaced or changed, making it possible to tailor the pistol to fit the shooter's preferences. This modularity has endeared the 2011 pistol to many shooting enthusiasts, who appreciate the ability to personalize their firearms.

Some of the top brands that produce 2011-style pistols include Staccato, Chambers Custom, and Wilson Combat. The 2011 pistol is a testament to the enduring appeal of John Browning's original design and the ability of the firearms industry to adapt and innovate. Combining the reliability and elegance of the 1911 with modern enhancements, the 2011 pistol is a formidable choice for anyone seeking a high-capacity, semi-automatic handgun that doesn't compromise on quality and performance.

U.S. Pat. No. 10,940,570 B2 that discloses a jig for finishing a workpiece with a handheld router or other handheld motor-driven rotational tool assembly. The jig includes a baseplate that is precisely aligned and attached to a router. A main guide is configured to precisely align with and fasten to the base plate in several different jig configurations and there is a support guide. Right-angle adaptors attach to the guides and precisely align with and attach to the guides and the base plate to form several different jig configurations. Side plates secure the workpiece there between and provide a surface along which the main guide may slide to facilitate finishing operations on the workpiece.

In is desired to devise a router jig that can be used without problems on hard materials such as steel and alloy steel frames along with softer materials such as aluminum frames can be cut/finished. It is further desired that the router jig be capable of completing a 2011 or 1911 pistol frame in an amount of time that reduces that required with conventional designs on the market by hours. Preferably the handheld router and end mill do the blunt of the work while cutting the remainder of material from the frame. The router Jig, should provide an easy way for an individual to complete a 2011/1911 80 percent pistol frame in many types of materials, while requiring only a fraction of the work or effort when compared to other designs or jigs currently on the market.

### BRIEF SUMMARY OF THE INVENTION

The UFS 2011/1911 Router Jig of the invention acts as a guide for a handheld router to

follow when cutting slide rails of a conventional 2011/1911 80% pistol frame and also utilizes, in addition to the handheld router, an end mill, and drill bits to remove the remaining 20% of metal/material from the pistol frame. Indeed, the unique guide bushing in conjunction with the alignment/support rail auto aligns a router base plate with jig side plates. When pushing the alignment/support rail against the jig side plate and tightening the screws, the guide bushing is allowed to rotate inside of the router base plate and auto align the router with the jig side plate. This ensures the user can easily align the router with the jig side plate and produce accurate and precise results.

The UFS 2011/1911 Router Jig allows the user to remove the remaining material accurately and precisely without the need for large and expensive machinery and equipment (cnc machine, knee mill, etc.) that would normally be required. The UFS 2011/1911 Router Jig provides guide holes to allow the user to drill the remaining unfinished holes accurately and precisely in the frame. Currently, I am unaware of any other product or jig on the market that allows the user to use a jig along with a handheld router to accomplish this task.

### BRIEF DESCRIPTION OF THE SEVERAL VIEWS OF THE DRAWINGS

For a better understanding of the present invention, reference is made to the following description and accompanying drawings, while the scope of the invention is set forth in the appended claims.

FIG. 1 is a side view of the router upon a UFS 2011/1911 router jig in accordance with an embodiment of the invention.

FIG. 2 is an isometric view of the embodiment of FIG. 1 but without the router as viewed from above, the rear and right side.

FIG. 3 is an exploded, isometric view of the embodiment of FIG. 2 as viewed from beneath, front and right side.

FIG. 4 is an exploded, isometric view of the embodiment of UFS 2011/1911 router jig FIG. 2 with the workpiece as viewed from the above, front and right side.

FIG. 5 is a bottom view showing all the components of a further embodiment of the UFS 2011/1911 router jig in a disassembled state. The router base plate hole configuration and arrangement differs from that of the hoe configuration and arrangement in the router base plate in FIGS. 1-4 and there is also shown an end mill and two drill bits and a further set of three screws.

FIG. 6 is a bottom view showing all the components of the embodiment of the UFS 2011/1911 router jig according to FIGS. 2-4 in a disassembled state.

FIGS. 7-10 are isometric views in progression showing a manner of assembly that secures a workpiece between side plates of the embodiment of FIGS. 2-4 and 6.

FIG. 11 has isometric views in progression for securing the router base plate to the handheld router.

FIG. 12 is an isometric view showing insertion of a collet being position relative to the handheld router.

FIGS. 13 and 14 are isometric views showing securement of alignment bushing to an opening of the router base plate, albeit with the router base plate of FIG. 5.

FIG. 15 is an isometric view showing securement of a bracket onto the alignment bushing in an opining of the router base plate.

FIG. 16 is an isometric view showing alignment of the router base plate to a router chuck via a tapered pin.

FIG. 17 is an isometric view showing securement of guide bushing to the router base pate.

FIG. 18 is an isometric view showing securement of a support rail to the router base plate.

FIG. 19 is a side view showing alignment of the router secured to the router base plate, which is upon a topmost side plate of the router jig that secures the workpiece between its side plates and with an end mill projecting from the router.

FIG. 20 is a side view enlargement of the region circled as A in FIG. 19.

### DETAILED DESCRIPTION OF THE INVENTION

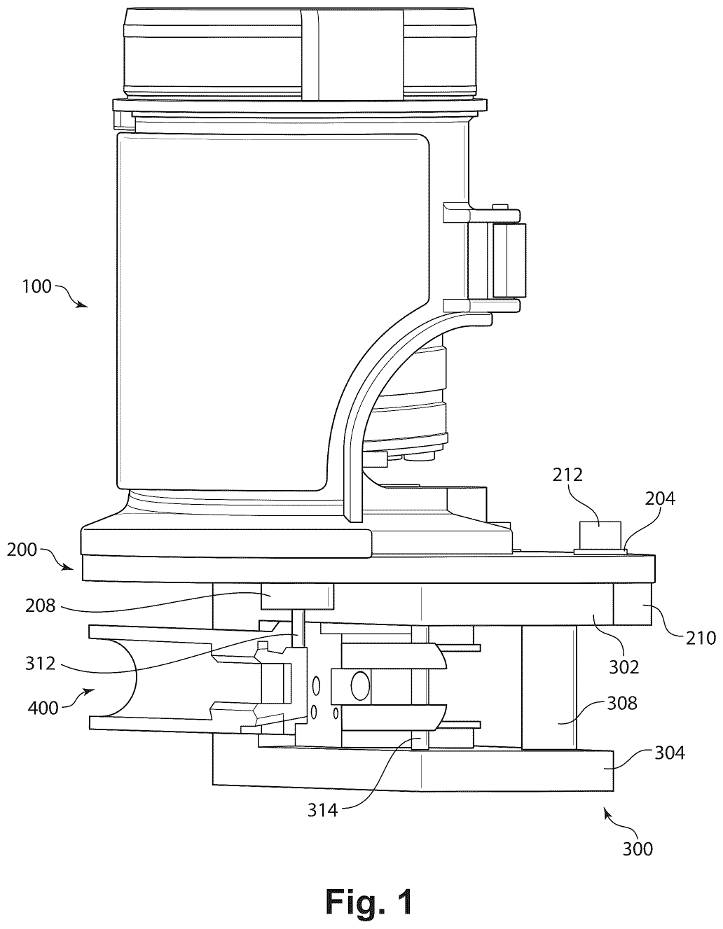

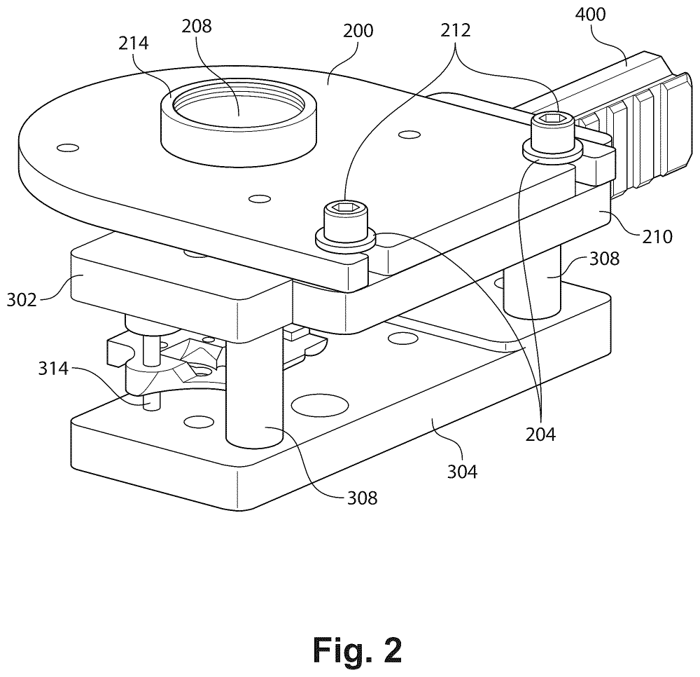

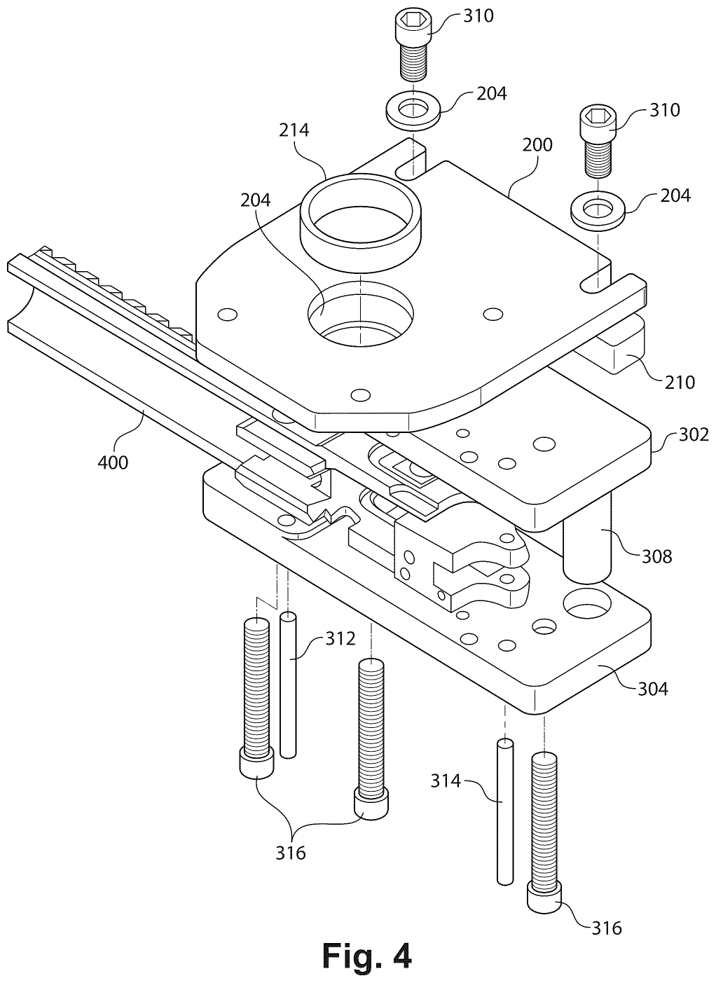

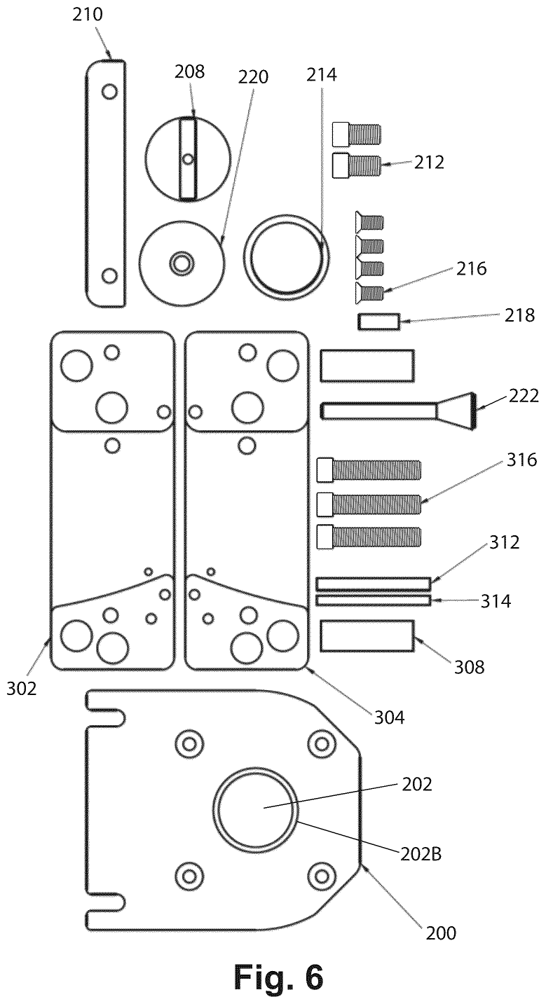

Turning to FIGS. 1-4, a handheld router 100 is secured to a router base plate 200. A router jig assembly 300 accommodates a workpiece 400, which may be a 2011 pistol frame that requires finishing or a 1911 pistol frame that requires finishing. The router jig assembly 300 includes two jig side plates 302, 304 between which is held stationary the workpiece 400. The router base plate 200 accommodates attachment of the router guide bushing 208 to the handheld router 100 and creates a flat surface that allows the handheld router 100 to guide smoothly across jig side plates 302, 304 while cutting side rails of the workpiece 300. FIG. 6 shows the components separately.

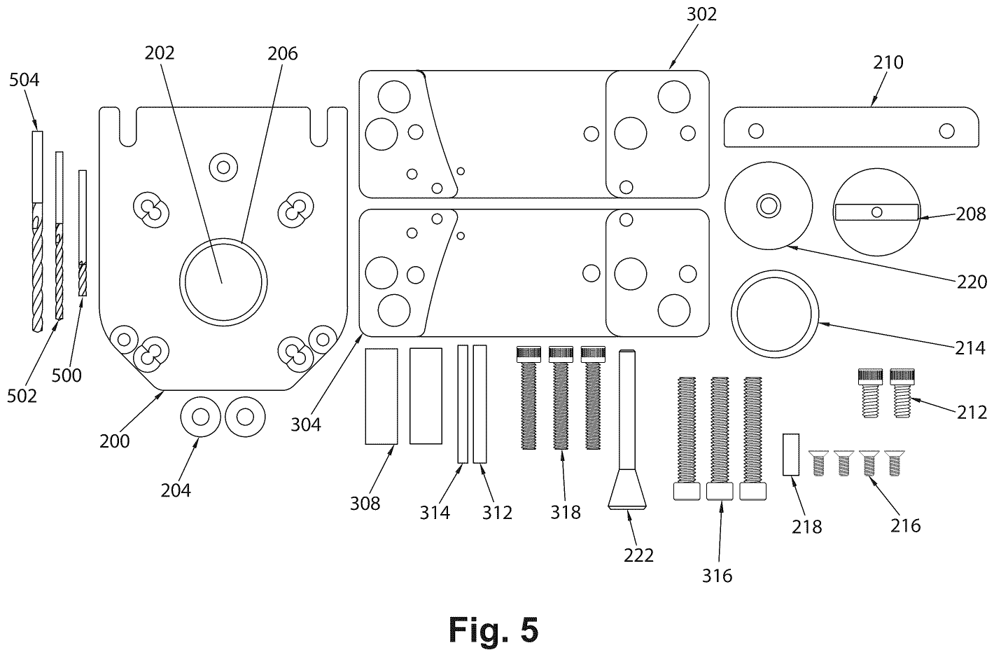

FIG. 5 shows the components as well, but with a router base plate 200 whose hole configuration and arrangement differs from that of FIG. 6 and also shows a pair of flat washers 204, an end mill 500, a pair of different drill bits 502 and an additional set of three screws 318. The router base plate 200 of FIG. 6 has a boss 202 (aperture) and four circular holes while the router base plate 200 of FIG. 5 has the boss 202 (aperture) and three circular holes and four pairs of adjacent holes that each define a shape that exceeds that of a semicircle but is smaller than a full circle.

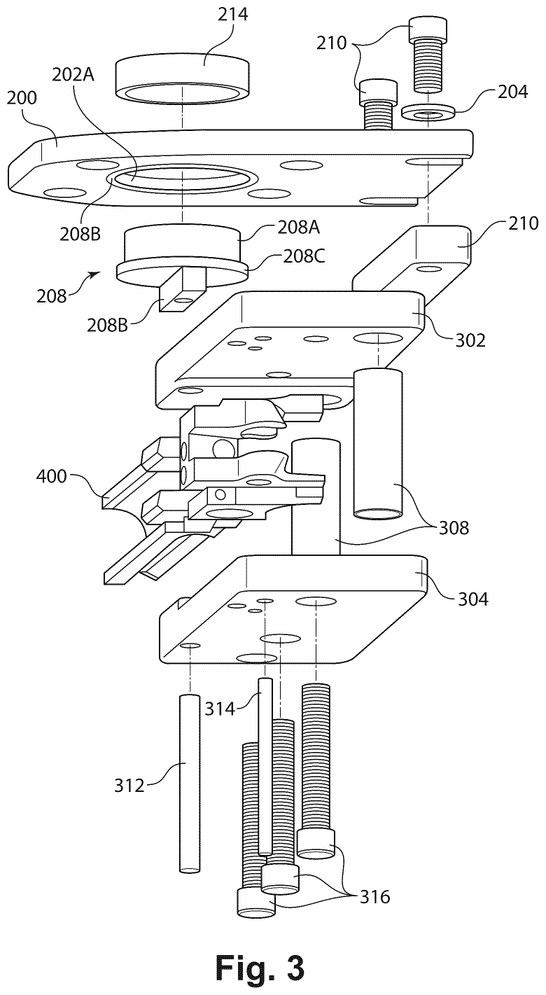

As seen in FIG. 3, the guide bushing 208 has a cylindrical portion 208A at one end and a linear portion 208B at the other with a flange portion 208C between that is wider than the cylindrical portion 208A as shown in FIG. 3. An aligned passage extends through each and an opening in the linear portion 208B is apparent in FIGS. 5 and 6. Aside from the passage shared in common by each, the portions 208A, 208B and 208C may all be solid. The underside of the router base plate 200 has a boss 202 or hole that accommodates insertion of the guide bushing 208. That is, the cylindrical portion 208A is fitted along a guide edge 202A of the boss 202 (aperture).

The flange portion 208C sits in a circular recess 202B of the boss 202. The depth of the circular recess 202B is preferably the same as the thickness of the flange portion 208C. Thus, both diameters of the guide bushing 208 (portions 208A and 208C) get inserted into the boss 202 of the router base plate 200. When fully inserted, the top flat area of the guide bushing 208 will be level or flat with the surface of the router base plate 200. The smaller diameter portion travels through the router base plate 200 and threads into the bushing nut 214. The wider portion 208C is used as a flange to keep the guide bushing 208 from going all the way through the aperture of the boss 202 in the router base plate 200, and to accurately locate the guide bushing 208 to the router base plate 200.

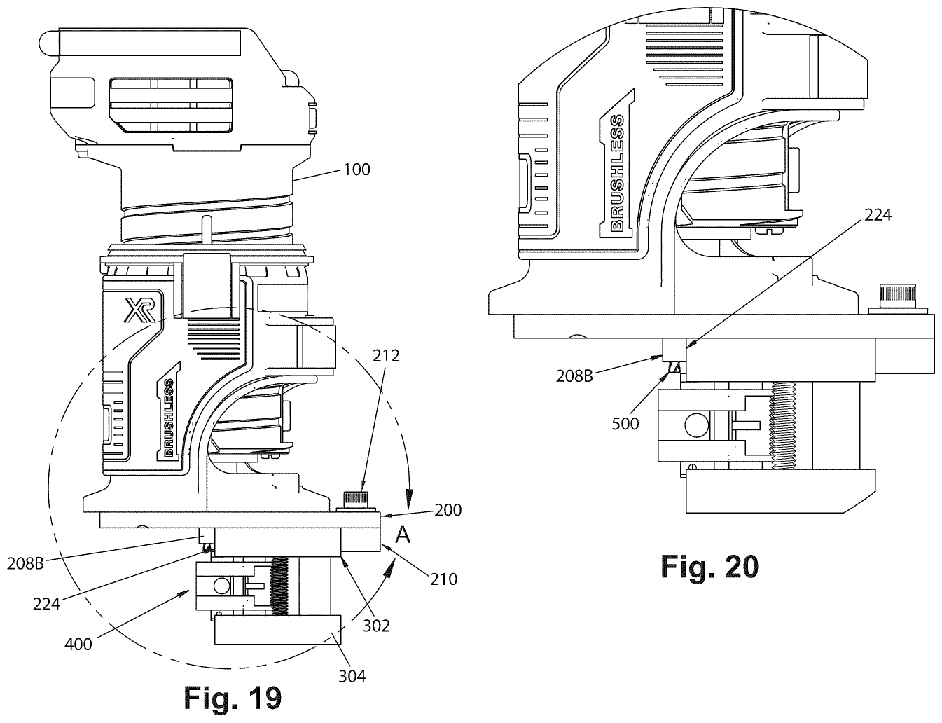

As can be seen in FIG. 19, the solid linear portion 208B of the guide bushing 208 (FIG. 3) projects downward to contact the leading edge 224 of the jig side plate 302 (FIG. 19). Thus, the leading edge 224 defines a locating edge surface for the guide bushing 208 to follow to enable the handheld router 100 to achieve accurate cutting and drilling results of the workpiece 400. The handheld router 100 will cut exactly the same on both sides of each jig side plate 302, 304, but only one side at a time. Once one side is completed, the user flips the router jig 300 over (i.e., flip the jig side plates 302,304 and frame over) and repeats the process.

A guide rail 210, which attaches or fastens to the router base plate 200 via two screws 212, helps align the router guide bushing 208 adjacent the leading edge 224 of the jig side plate 302 and to create a stable, supporting platform for the handheld router 100 to stay mounted on top of the router base plate 202 and works in conjunction with the router guide bushing 208 to achieve an auto align function.

The auto align function basically is a manual squeezing of the jig side plates 302, 304 between the linear portion 208B of the guide bushing and the guide rail 210. This helps align everything and keeps the router from falling off if the user lets go of the router 100. When the handheld router 100 is mounted to the router base plate 200, one may rotate the handheld router 100 in an axial manner and still keep the guide bushing 208 aligned with the locating edge of the jig side plate 302. This happens by the guide bushing 208 rotating inside the boss 202 or locating hole inside of the router base plate 200.

The router guide bushing 208 preferably screws through the router base plate 200 and into a bushing nut 214 to create an accurate locating edge for the handheld router 100 to cut the slide rails of the work piece 400 and works in conjunction with the guide rail 210 to achieve the auto align function. The bushing nut 214 is screwed onto the router guide bushing 208 after the router guide bushing 208 is inserted through the router base plate 200 to ensure the router guide bushing 208 is secured to the router base plate 200. The router guide bushing 208 may still rotate to achieve the auto align function.

There are support spacers 308, which act as structural support for the router jig 300, assembly screws 310, which secure the guide rail 210 and the router base plate 200 together, and locating pins or bars 312, 314 which align/locate the router Jig 300 and the work piece 400 together to ensure final machining or finishing of the work piece 400 is dimensionally correct.

The components shown in FIGS. 5 and 6 include the jig side plates 302, 304, the guide rail 210 (or an alignment/support rail 210), the guide bushing 208, a router alignment bushing 220, the bushing nut 214, two support rail screws 212, four router base plate screws 216, a reducer collet 218, three side plate screws 316 for use with a 1911 pistol frame as the workpiece 400, a router alignment tapered pin or bar222, a locating pin or bar312, a locating pin or bar 314, two support spacers 308, a router base plate 200. With respect to FIG. 5 only, there is also shown a conventional a 3 mm end mill 500, a #35 drill bit 502, a #22 drill bit 504, two flat washers 204 and three side plate screws 318 for use with a 2011 pistol frame as the workpiece 400.

Also, as concerns the router base plate 200, the arrangement and configuration of screw holes differ in FIGS. 5 and 6. In the case of FIG. 5, the arrangement and configuration of holes render the router base plate 200 is compatible with conventional routers such as Craftsman model no. CMCW400B, Dewalt model nos. DCW600B and DWP611, Bosch model no. GFK125CE, Hercules model no. HB043. In the case of FIG. 6, the router base plate 200 is compatible with a single router model. The router base plate has a plurality of holes spaced away from the aperture of a boss and are arranged in a symmetric manner from the aperture. The holes include circular holes and include sets of pairs of adjoining holes each of the adjoining holes defining a radial edge that extends less than that of a full circle and more than that of a semicircle. Preferably there are at least two or three sets of holes with each of the sets of holes arranged in a symmetric manner from the aperture and each of the sets of the holes being radially spaced away from the aperture by different radial distances with respect to each other so that one of the sets of holes is further away from the aperture than another of the sets of holes.

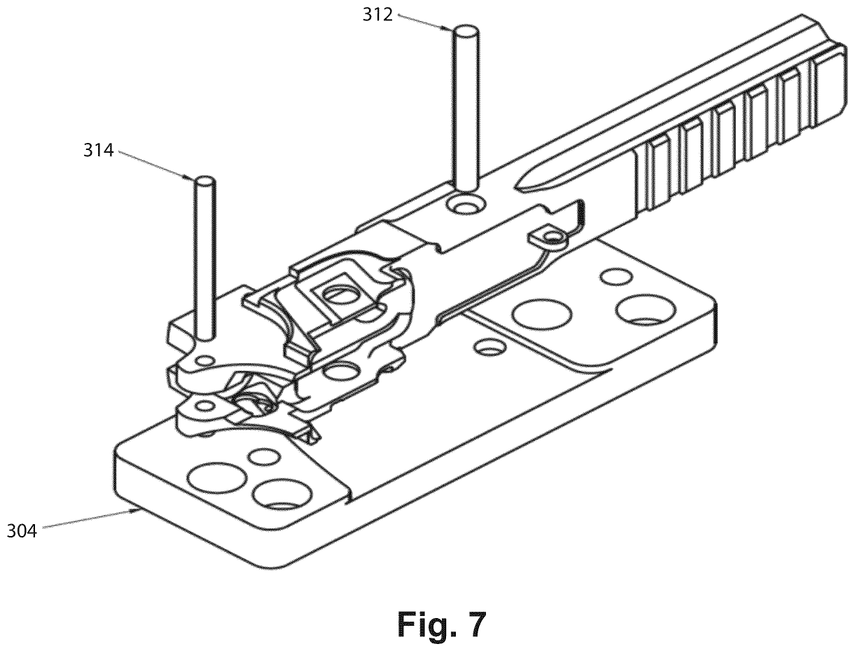

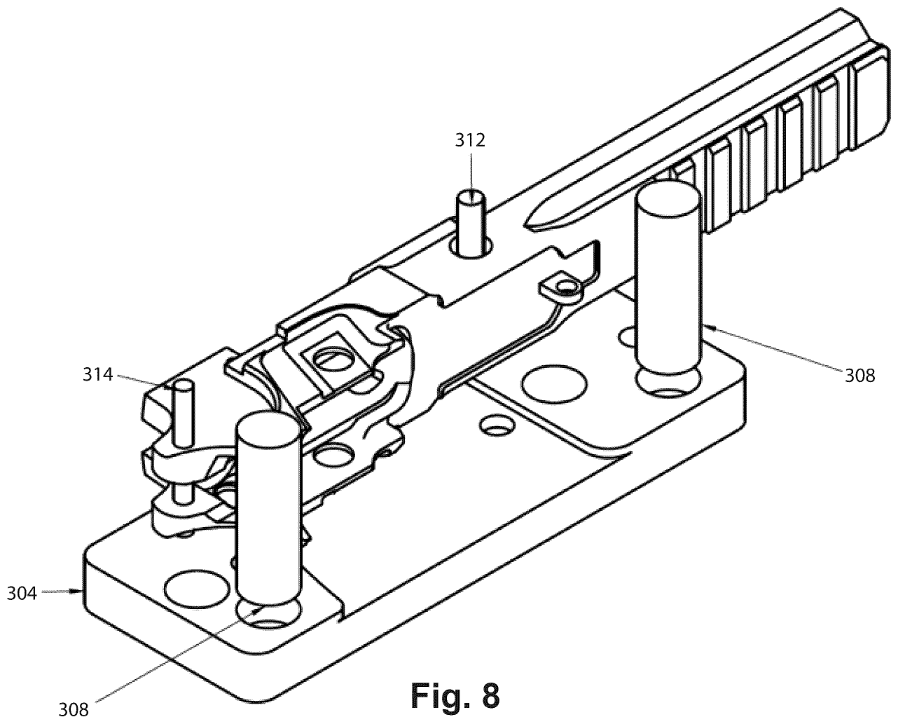

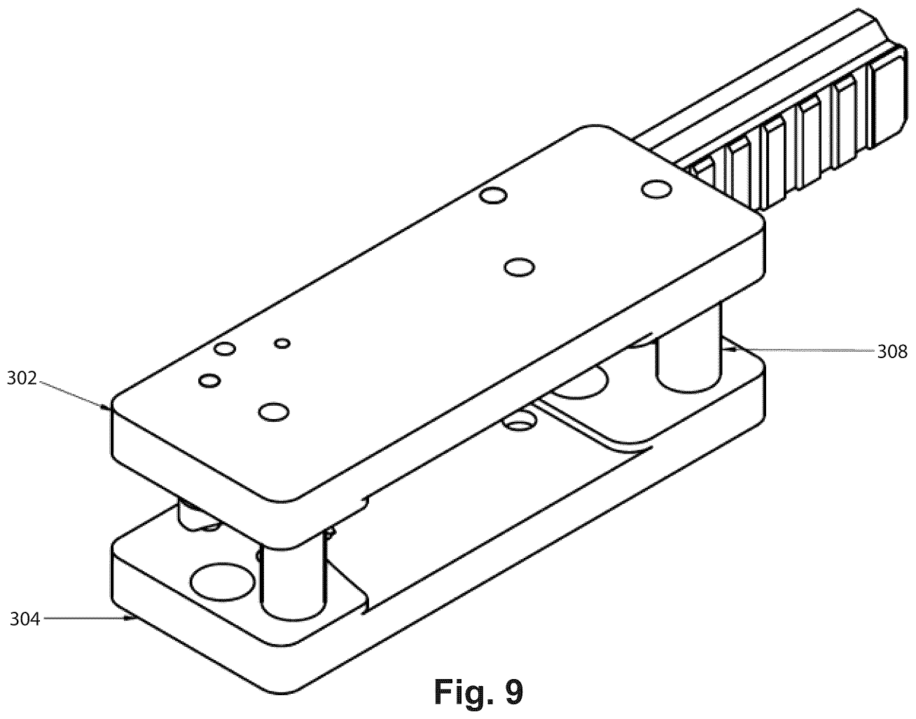

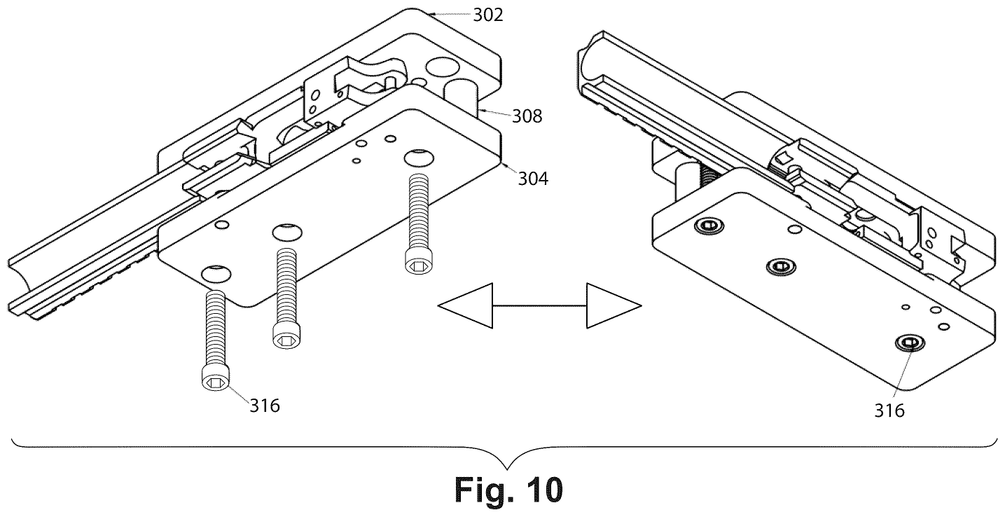

Referring to FIG. 7-10, the work piece 400 is sandwiched between two jig side plates 302, 304 that are separated from each other by two support spacers 308 whose ends are fitted into associated recesses in the jig side plates 302, 304. Two locating pins or bars 312, 314 pass through two holes 402, 404 respectively in the work piece 400 and their ends are fitted into aligned recesses in the jig side plates 302, 304. FIG. 10 shows that three hex head threaded screws 316 for a 1911 pistol frame as the work piece 400 are threaded into aligned holes in the two jig side plates 302, 304 to keep the two jig side plates 302, 304 in their spaced apart relation and thereby keep the work piece 400 in its stationary position between the two jig side plates 302,304. For a 2011 pistol frame as the work piece 400 instead, hex head threaded screws 316A are used instead of the hex head threaded screws 316.

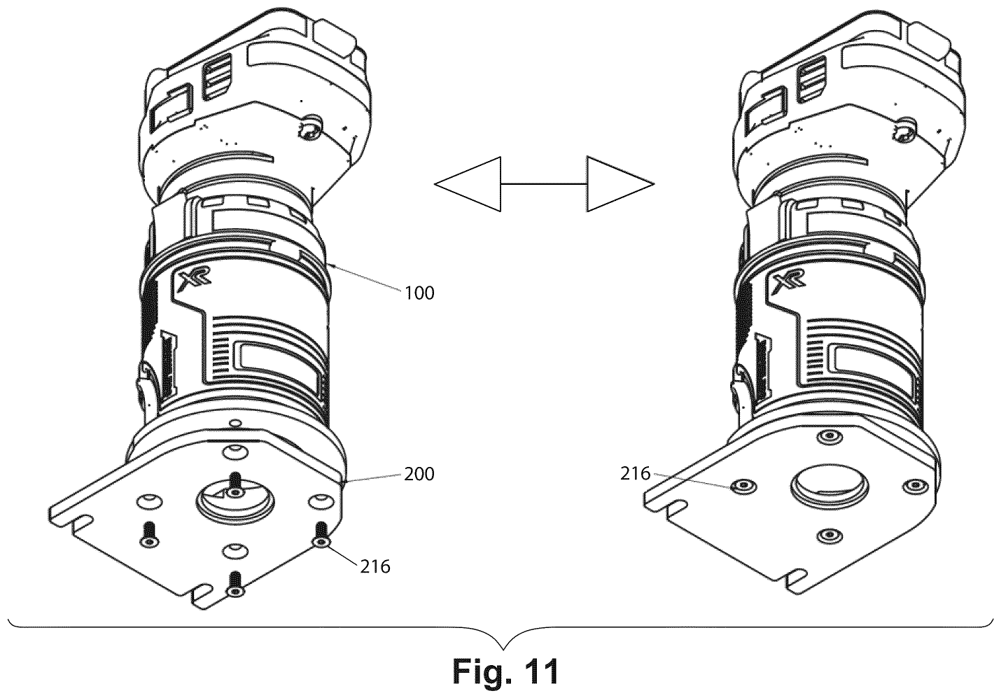

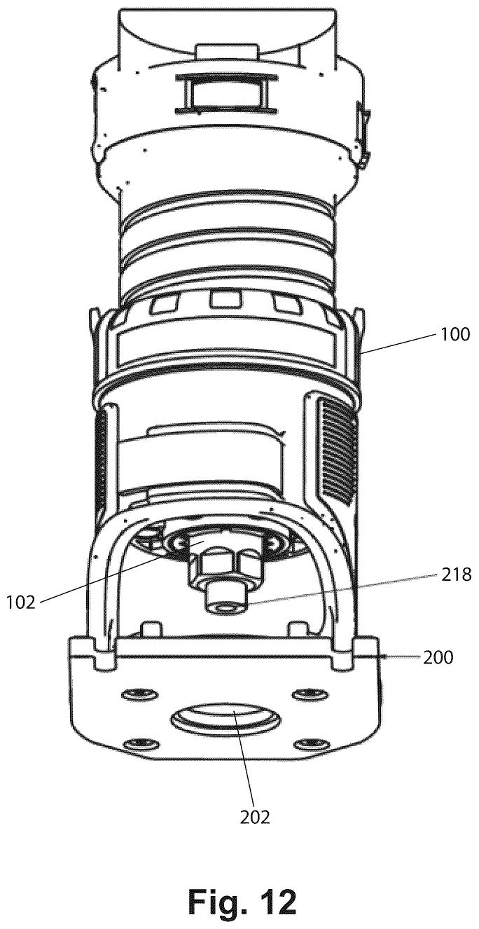

After disconnecting power to the handheld router 100, the sequence of steps represented by FIGS. 11-14 may be followed. Initially, align four base plate screw holes with four tapped screw holes on the handheld router 100 and insert four countersunk screws 216 though the router base plate 202 and into the router base plate 202 (FIGS. 11, 12).

Turning to FIGS. 12, 13, 14 and 15, insert the collet 218 to the router base plate 202 by inserting the router alignment bushing 220 through the boss 202 (aperture) in the router base plate 200. The outer flange of the router alignment bushing 220 should sit inside a boss recess 206 on the router base plate 200 outward from the opening into which is inserted the router alignment bushing 220. Hand tighten the bushing nut 214. The router depth control gauge/sleeve may be removed from the handheld router 100 to carry out this insertion and the re-installed after the router alignment bushing 220 and bushing nut 214 are secured to the router base plate 202. The router base plate 202 then needs to align to a router chuck 102 via a tapered pin or bar222. The router depth adjustment level then needs to be locked while doing the alignment.

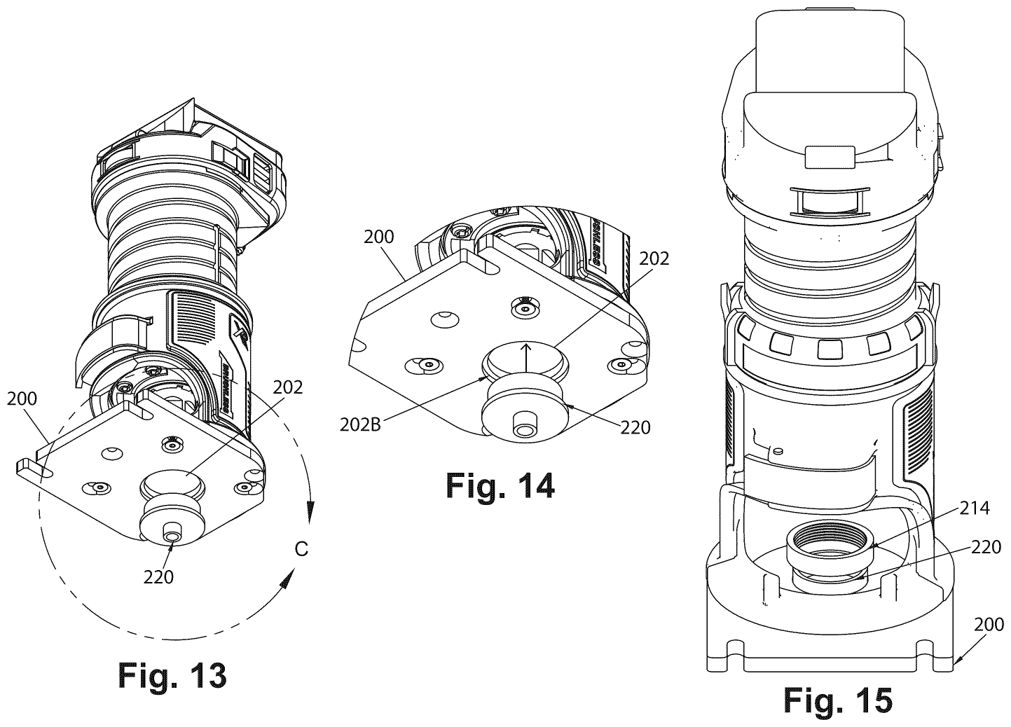

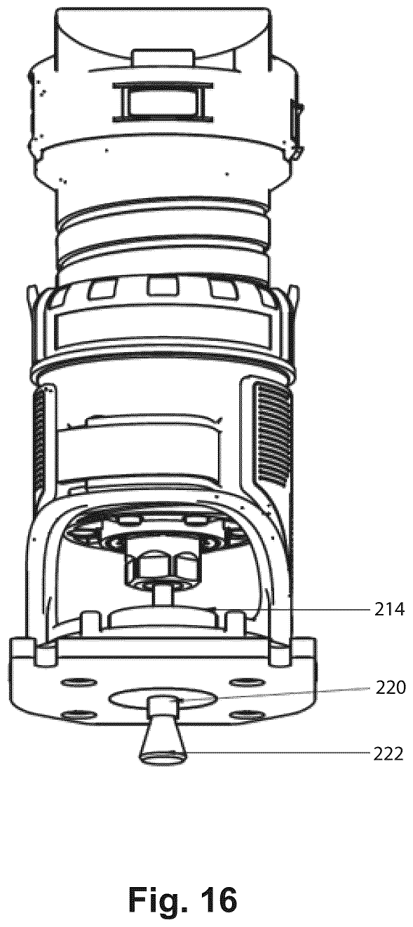

Turning to FIG. 16, the tapered pin or bar 222 is inserted through the router alignment bushing 220 and into the collet 218. The taper of the tapered pin or bar 222 needs to touch the top of the router alignment bushing 220 to self-center. After self-tightening the router chuck 102 (FIG. 12), finish tightening the four countersunk base plate screws 216 to achieve alignment of the router base plate 200 (FIGS. 13-15) with the router chuck. Both the tapered pin or bar 222 and the router alignment bushing 220 may be removed from the router base plate 200.

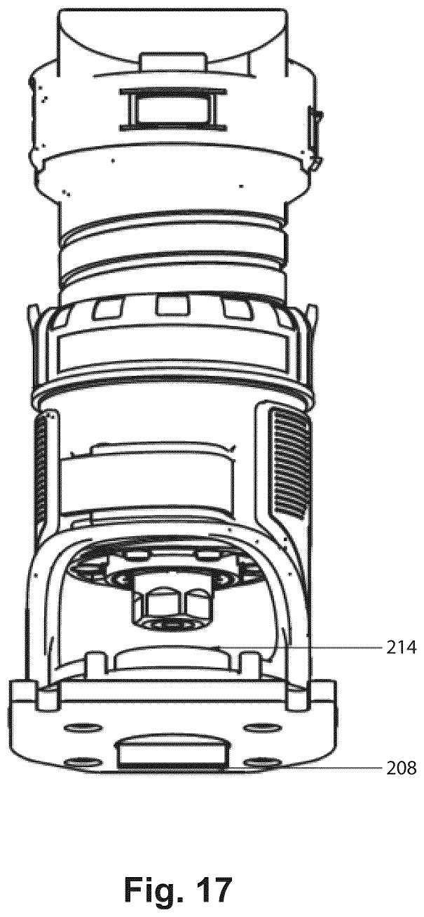

Turning to FIG. 17, the router guide bushing 208 is installed onto the router base plate 200 by inserting the router guide bushing 208 through the boss 202 (aperture) the router base plate 200 and screwing onto the bushing nut 214 from the other side of the router base plate 200. The outer flange of the guide bushing 214 sits inside the boss 202 of the router base plate 200. Hand tighten the bushing nut 214. The router guide bushing 208 will be tight but will slightly rotate, which allows for the auto align function.

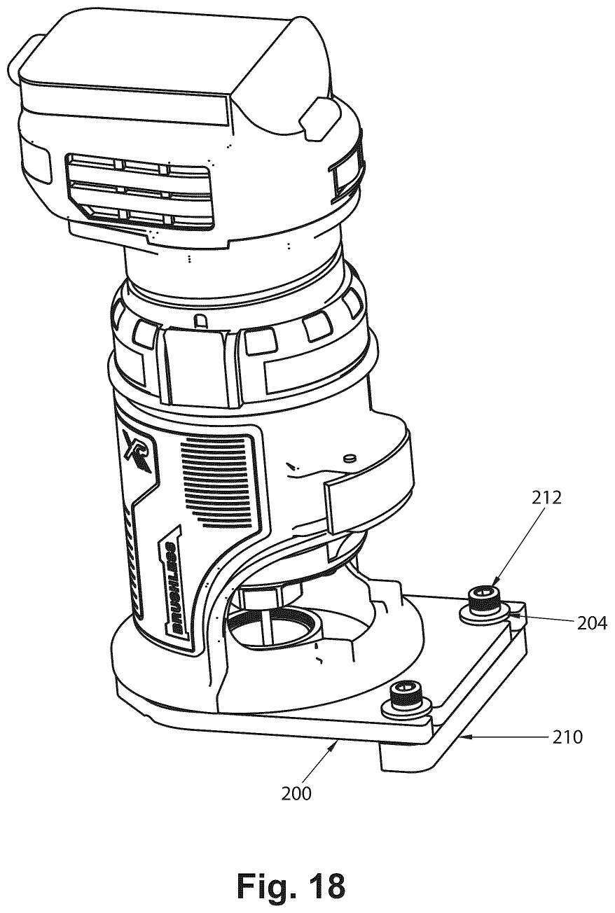

Turning to FIG. 18, the guide rail 210 is placed below the router base plate 200 to where threaded holes line up with the slots in the router base plate 200. Screws 212 are inserted through the slots in the router base plate 200 and threaded into the tapped holes of the guide rail 210 and then manually tightened.

Turning to FIG. 18, the handheld router 100 and router base plate 200 are aligned with the work piece 400 sandwiched between the jig side plates 302, 304 of the router jig assembly 300. A vise may be used to hold stationary the work piece 400 and the jig side plates 302, 304. The handheld router 100 and router base plate 200 secured together are placed on the jig side plate 202. While holding the handheld router 100 upright and pushing the router guide bushing 208 against a locating edge 224 of the jig side plate 302, the guide rail 210 are pushed against the opposite side of the jig side plate 302.

As a consequence, the router guide bushing 208 may rotate inside the boss 202 of the router base plate 200 to allow for the auto align function to align the router guide bushing 208 and the guide rail 210 with the parallel sides of the jig side plates 302, 304.

Turning to FIGS. 19 and 20, make sure a router depth control is high enough to not allow the end mill 500 to hit the work piece 400. A vise and vise parallels are needed to hold stationary the work piece 400 and the mounted jig side plates 302, 304. Place the router 100 and attached router base plate 200 on top of the jig side plate 302 while holding the router 100 upright and pushing the guide bushing 308 against the locating edge 224 of the jig side plate 302 and push the guide rail 310 against the opposite side of the jig side plate 302.

While keeping pressure and with the router base plate 200 aligned, the two screws are tightened. The handheld router 100 and router base plate 200 are aligned and mounted securely to the jig side plates 302, 304. The router may cut the work piece 400 parallel and accurately along the jig side plates 302, 304. The end mill 500 may be used for cutting and is driven by the router 100. The tip of the end mill 500 extend through an opening in the linear portion 208B of the guide bushing 208.

At this point, the guide bushing 308 may rotate inside the boss 202 of the router base plate 200 to allow for the auto align function to align the guide bushing 308 and guide rail 310 with the parallel sides of the jig side plate 302. This enables the router 100 to cut parallel and accurately along jig side plates 302, 304. While keeping side and downward pressure and router base plate 200 aligned, tighten the two screws but do not over tighten and strip the threaded holes in the guide rail 310. The handheld router 100 and the router base plate 200 are aligned and mounted securely to the jig side plates 302, 304. The handheld router 100 should be able to slide across the side plate 302 fairly easily.

After the rail cuts are complete, drill the hammer pin or bar and sear pin or bar holes with the drill bits 502, 504. Use the per-drilled and labeled holes in the jig side plates as a drill guide. it is recommended to use a drill press with a vise and parallels if possible, but a hand drill may be used instead if necessary. Make sure the jig side plates 302, 304 and work piece 400 are level and the drill bit 502 or 504 is properly aligned. A conventional drilling fluid may be used in this process of drilling just half way through the work piece 400 from one side and then flip the jig side plates 302, 304 and work piece 400 over and drill again from the opposite side.

What has been described is a router jig 300 for holding stationary a work piece 400 to be cut by a router 100 secured to a router base plate 200. The router base plate 200 has a boss 202 (aperture) bounded by a recess 202B, which is adjacent to and extending radially outward from a guide edge 202A of the boss 202. Also provided is router guide bushing 208, which has a cylindrical portion 208A that fits into the boss 202, a flange portion 208B that sits in the recess 202B, and a linear portion 208C having an associated surface. The router guide bushing 208 may rotate in the boss 202. A pair of jig side plates 302, 304 of the router jig 300 are spaced apart from each other and each has opposite sides that are parallel to each other. One of the opposite sides of one of the jig side plates of the pair of jig side plates defining a locating edge 224. The router guide bushing 208 may rotate into a position so that the associated surface of the linear portion 208B faces the locating edge 224. A guide rail 210 is fastened to the router base plate 200 and has a further surface that faces another of the opposite sides of the one of the jig side plates. The guide rail 210 and the linear portion 208B of the router guide bushing 208 are in a pressed or squeezed condition. The associated surface of the linear portion 208B of the router guide bushing 208 is aligned with the locating edge 224 to create a stable, supporting platform for the handheld router 100 to stay mounted to the router base plate 200 as the handheld router 100 moves relative to the pair of jig side plates 302, 304.

While the foregoing description and drawings represent the preferred embodiments of the present invention, it will be understood that various changes and modifications may be made without departing from the scope of the present invention.

What is claimed is:

1. A router jig for holding stationary a work piece to be cut by a handheld router, comprising:
a router base plate having a boss that defines an aperture and a recess, which is adjacent to and extending radially outward from the aperture;
a router guide bushing having a cylindrical portion that fits into the aperture, a flange portion that sits in the recess, and a linear portion having an associated surface and having an opening, the router guide bushing being rotatable in the aperture;
a pair of jig side plates spaced apart from each other and each having opposite sides that are parallel to each other, one of the opposite sides of one of the jig side plates of the pair of jig side plates defining a locating edge, the router guide bushing being rotatable into a position so that the associated surface of the linear portion faces the locating edge;
a guide rail that is fastened to the router base plate and has a further surface that faces another of the opposite sides of the one of the jig side plates,
wherein the guide rail and the linear portion of the router guide bushing are in a pressed condition, the associated surface of the linear portion of the router guide bushing being aligned with the locating edge to create a stable, supporting platform for the handheld router to stay mounted to the router base plate and that is configured and arranged to guide movement of the handheld router across the one of the jig side plates as the handheld router cuts rails of the work piece between the pair of jig side plates.

2. The router jig of claim 1, wherein the linear portion has a length longer than a width of the linear portion, the flange portion extending outward from between the liner portion and the cylindrical portion and sitting in a recess of the router base plate that extends outward from the aperture.

3. The router jig of claim 1, wherein the jig side plates each have parallel sides, the router guide bushing and guide rail and the pair of jig side plates all being arranged relative to each other so as to trigger an auto align function that aligns the router guide bushing and the guide rail with one of the parallel sides of the jig side plates as the guide rail presses against an opposite one of the parallel sides of the one of the jig side plates.

4. The router jig of claim 1, wherein the router base plate has a plurality of holes spaced away from the aperture that are arranged in a symmetric manner from the aperture.

5. The router jig of claim 4, wherein the holes include circular holes and include sets of pairs of adjoining holes each of the adjoining holes defining a radial edge that extends less than that of a full circle and more than that of a semicircle.

6. The router jig of claim 6, wherein the plurality of holes include at least two sets of holes with each of the sets of holes arranged in a symmetric manner from the aperture and each of the sets of the holes being radially spaced away from the aperture by different radial distances with respect to each other so that one of the sets of holes is further away from the aperture than another of the sets of holes.

7. The router jig of claim 1, further comprising:
spacers configured and arranged to space apart the pair of jig side plates from each other; and
pins or bars extending between the pair of jig side plates.

8. The router jig of claim 1, wherein the pair of jig side plates each have a respective plurality of holes in alignment with each other that accommodate ends of respective ones of spacers that space apart the pair from each other, pins or bars that extend through passages in a work piece between the pair, and fasteners that join the pair to each other.

9. The router jig of claim 1 in combination with the work piece, further comprising:
pins or bars that pass-through openings in the work piece and having ends retained in position by the pair of jig side plates so as to keep stationary the work piece between the pair of jig side plates, the work piece being a pistol frame.

10. The router jig of claim 1 in combination with the work piece, wherein the work piece is between the jig side plates and is a frame piece of a pistol frame. The router jig of claim 10 in combination with the work piece, wherein the frame piece 11. of the pistol frame is a 1911 pistol frame.

12. The router jig of claim 10 in combination with the work piece, wherein the frame piece of the pistol frame is a 2011 pistol frame.

13. The router jig of claim 10 in combination with the work piece and in further combination with the handheld router, the handheld router being secured to the router base plate.

14. The router jig of claim 10 in combination with the work piece and in further combination with the handheld router, wherein the handheld router is secured to the router base plate, further comprising:
an end mill driven by the handheld router and extending through the opening in the linear portion of the router guide bushing, the end mill having a tip that projects out of the opening.
